(19) United States
(12) Patent Application Publication
(10) Pub. No.: US 2022/0001292 A1
(43) Pub. Date: Jan. 6, 2022

(54) PROGRAMMABLE TOY BUILDING BLOCKS SYSTEM

(71) Applicant: SAIFENG CHEN, Los Angeles, CA (US)

(72) Inventor: SAIFENG CHEN, Los Angeles, CA (US)

(21) Appl. No.: 17/330,695

(22) Filed: May 26, 2021

Related U.S. Application Data
(60) Provisional application No. 63/040,533, filed on Jun. 18, 2020.

(51) Int. Cl. A63H 33/04; A63H 30/04

(52) U.S. Cl. CPC A63H 33/042; A63H 2200/00; A63H 30/04

(57) ABSTRACT

A programmable assembly toy system, including: a multiplicity of first function modules, each of the first function module having a first surface to fit into one or more parameter modules, each parameter module having a memory for storage a computer program command forming a computer program with each parameter module; and a physical presentation object connected with a trigger module in a wireless connection or a wired connection and performing a preconfigured action; wherein the trigger module is jointed with one or more first function modules responsive to an external trigger action to trigger the preconfigured action.

### FIELD OF THE DISCLOSURE

The present disclosure relates to a programmable assembly toy system, and more particularly, an electronic educational toy that teaches the logic of programming without an understanding of concepts involved in programming.

### BACKGROUND OF THE DISCLOSURE

In recent years, with the advances in technology and the overwhelming number of opportunities it has brought to the table, there is no denying that programming has become the new language in the world. Programming language is comprising a set of instructions that produces various kinds of outputs which can be used by engineers to express their ideas and control the computer programs. Coding ability will become a general skill in the future and children should begin to learn programming language at young age. More importantly, learning programming language can boost children's intelligence because programming language bases on strong logical thinking. However, teaching children coding knowledge is complex for most parents and it is important to get the kids interested during daily life, so coding training and learning materials are needed for parents to get children get to know coding at home.

Conventionally, many coding training and learning materials have been proposed for children. These materials are provided in various forms, such as coding robot toy which is intended to teach children how to control the robot by putting the units arranged in orderly rows. However, this coding robot toy is too easy to improve children's logical thinking and coding ability, and it does not consist basic grammar of programming language which is the basis for understanding programming language.

For example, U.S. Pat. No. 2019/0022539 to Kamata and Ito disclose a coding toy includes a control object (a figure body) having a control unit, an input unit and an output unit, and a part (an icon block) having a code identifier (an icon) that corresponds to a control detail of the control object. The control unit of the control object obtains code identifier information and positional information from the code identifier indicated by the part disposed in a predetermined position and the position of the part and controls the output unit to a control detail and in a control sequence that are determined by the code identifier information and the positional information. However, the controlling of this coding toy does not consist basic logical thinking of programming language grammar. Putting control unit in a sequence to control the conduct of the object (a figure body)

### BRIEF SUMMARY OF THE DISCLOSURE

In a general implementation, a programmable assembly toy system comprises a multiplicity of first function modules, each of the first function module having a first surface to fit into one or more parameter modules, each parameter module having a memory for storage a computer program command forming a computer program with each parameter module; and a physical presentation object connected with a trigger module in a wireless connection or a wired connection and performing a preconfigured action; wherein the trigger module is jointed with one or more first function modules responsive to an external trigger action to trigger the preconfigured action.

In another aspect combinable with the general implementation, the programmable assembly toy system further comprises a computer either in the trigger module or in the physical presentation object to execute the computer program.

In another aspect combinable with the general implementation, the action performing by the physical presentation object is responsive to the corresponding computer program command.

In another aspect combinable with the general implementation, the first function modules comprises a direction module, a move module, a LED module, a sound module, and a loop module, wherein one of the first function modules is horizontally connected the other one or more first function modules in a side by side connection.

In another aspect combinable with the general implementation, the parameter modules comprises a direction parameter module, the direction parameter module comprising a left-turn parameter module having a memory for storage a left-turn command, a right-turn module having a memory for storage a right-turn command, and one or more degree parameter module for storage a degree parameter command.

In another aspect combinable with the general implementation, the direction parameter module is responsive to the direction module and is not responsive to the move module, the LED module, the sound module, and the loop module.

In another aspect combinable with the general implementation, the parameter modules further comprises a move parameter module, the move parameter module comprising a speed parameter module having a memory for storage a speed command, a forward move parameter module having a memory for storage a forward move command, a backward move parameter module having a memory for storage a backward move command, and a distance parameter module having a memory for storage a distance move command.

In another aspect combinable with the general implementation, the move parameter module is responsive to the move module and is not responsive to the direction module, the LED module, the sound module, and the loop module.

In another aspect combinable with the general implementation, the parameter modules further comprises a LED parameter module, the LED parameter module comprising one or more light parameter modules having a memory for storage a light parameter command with each light parameter module, one or more time parameter modules having a memory for storage a time parameter command with each time parameter module, and one or more frequency parameter modules having a memory for storage of a frequency parameter command with each frequency parameter module.

In another aspect combinable with the general implementation, the LED parameter module is responsive to the LED module and is not responsive to the move module, the direction module, the sound module, and the loop module.

In another aspect combinable with the general implementation, the parameter modules further comprises a sound parameter module, the sound parameter module comprising one or more music parameter module having a memory for storage of a music parameter command with each music parameter module and a frequency parameter module for storage of a frequency parameter command.

In another aspect combinable with the general implementation, the parameter module further comprises one or more control number parameter modules, each of the control number parameter module being stacked the time parameter module or the frequency parameter module of the LED parameter module, each of the control number parameter module being stacked the frequency parameter module of the sound parameter module.

Another aspect of the embodiment is directed to a programmable assembly toy system, comprising: a multiplicity of second function modules, each of the second function modules having a programming figure corresponding to a preconfigured action; a physical presentation object connected with a trigger module in a wireless connection or a wired connection and performing the preconfigured action; wherein the programmable figure is captured by a visual recognition module, in the trigger module or the physical presentation object, to form a computer program; wherein the trigger module is responsive to an external trigger action to trigger the preconfigured action.

In another aspect combinable with the general implementation, the programmable assembly toy system further comprises a computer either in the trigger module or in the physical presentation object to execute the computer program.

Another aspect of the embodiment is directed to a programmable assembly toy system, comprising: an input function module connected with a trigger module in a wireless connection or a wired connection and creating a computer program command to form a computer program corresponding to a preconfigured action; a physical presentation object connected with the trigger module in a wireless connection or a wired connection and performing the preconfigured action; and a computer either in the trigger module or in the physical presentation object to execute the computer program; wherein the trigger module is responsive to an external trigger action to trigger the preconfigured action.

In another aspect combinable with the general implementation, the input function module is a touch screen.

In another aspect combinable with the general implementation, the input function module is a keyboard.

In another aspect combinable with the general implementation, the input function module is a compatible personal device which is capable to create the computer program command.

In another aspect combinable with the general implementation, the programmable assembly toy system further comprises a voice recognition module, in the trigger module or the physical presentation object to recognize an external voice source to form the computer program command.

In another aspect combinable with the general implementation, each of the first function modules is two-dimensionally connected with each other and each of the function parameter module is three-dimensionally stacked with each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an embodiment of a programmable assembly toy system according to an aspect of the embodiment.

FIG. 2 is a top view of a direction module of the programmable assembly toy system of FIG. 1.

FIG. 3 is a top view of a move module of the programmable assembly toy system of FIG. 1.

FIG. 4 is a top view of a LED module of the programmable assembly toy system of FIG. 1.

FIG. 5 is a top view of a frequency parameter module and control number parameter module of the programmable assembly toy system according to an aspect of the embodiment.

FIG. 6 is a top view of a sound parameter module of the programmable assembly toy system according to an aspect of the embodiment.

FIG. 7 shows a bottom view of the parameter module and also shows a top and bottom view of the control number parameter module of the programmable assembly toy system according to an aspect of the embodiment.

FIGS. 8A-8B are a top view and a perspective view of the direction module, respectively.

FIGS. 8C-8D are a top view and a perspective view of the move module, respectively.

FIGS. 9A-9B are a front view and a rear view of the sound module, respectively.

FIGS. 9C-9D are a top view and a perspective view of the LED module, respectively.

FIGS. 10A-10B are top views of the trigger module.

FIGS. 10C-10D are side views of the first function modules, showing that the female port of the direction module is magnetically connected with the male port of the move module.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

Unless defined otherwise, all technical and scientific terms used herein have the same meaning as commonly understood to one of ordinary skill in the art to which this invention belongs. Although any methods, devices, and materials similar or equivalent to those described can be used in the practice or testing of the invention, the exemplary methods, devices, and materials are now described.

As used herein, the term “an external trigger action 200” could be any member which could generate a force to activate a trigger module 120. The external trigger action 200 may e.g., be a human finger. Alternatively, the external trigger action could an external voice source 200 which is capable to trigger a voice recognition module 122, in the trigger module 120 or a physical presentation object 300.

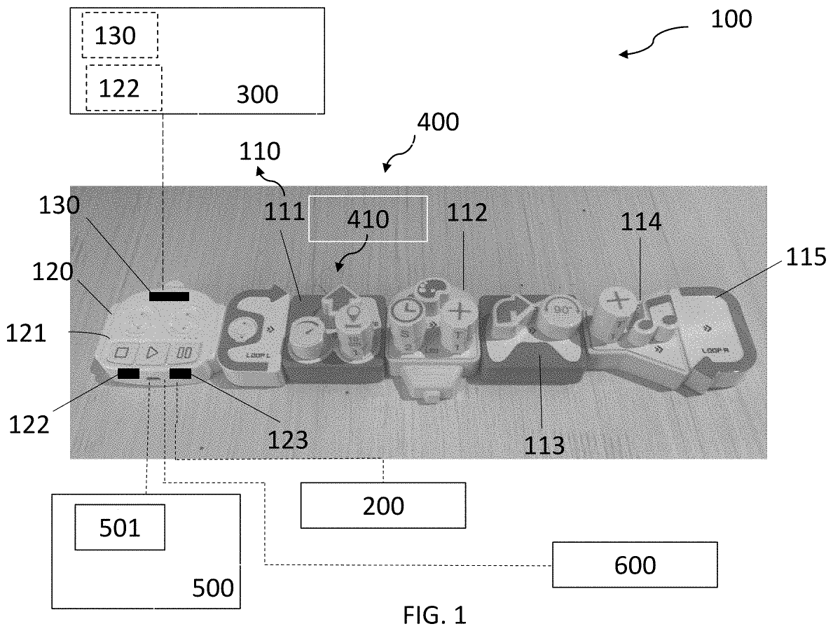

FIG. 1 generally depicts the basic architecture of a programmable assembly toy system 100 in accordance with the one of the disclosed embodiments. The programmable assembly toy system 100 comprises a multiplicity of first function modules 110 and each of the first function module 110 having a first surface to fit into one or more parameter modules 400, wherein the first function modules 110 comprises a direction module 113, a move module 111, a LED module 112, a sound module 114, and a loop module 115, wherein each of the first function modules 110 is horizontally connected with the other one or more function modules in a side by side connection. In other words, each of the first function modules is two-dimensionally connected with each other.

As shown further in FIG. 1, the programmable assembly toy system 100 further comprises a trigger module 120 may be jointed with one or more first function modules 110 and the physical presentation object 300 is connected with the trigger module 120 in a wireless connection or a wired connection, wherein the physical presentation object 300 is triggered by the trigger module 120 to perform a preconfigured action.

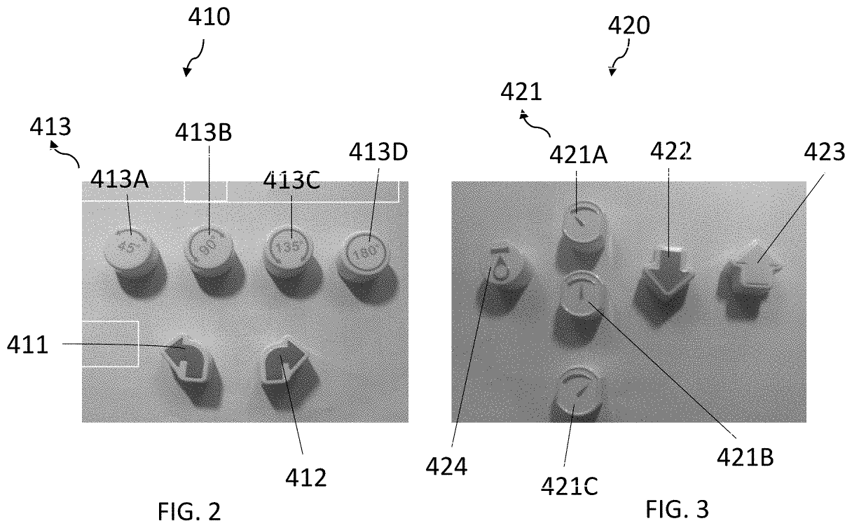

In some embodiments, as shown in FIG. 2, the parameter modules 400 comprises a direction parameter module 410, wherein the direction parameter module 410 comprises a left-turn parameter module 411 having a memory for storage a left-turn command 411, a right-turn parameter module 412 having a memory for storage a right-turn command 412, and one or more degree parameter modules 413 for storage a degree parameter command 413, wherein the degree parameter modules 413 comprises one or more predetermined degrees of parameter modules, preferably, a 45° parameter module 413A for storage of a 45° turn command 413A, a 90° parameter module 413B for storage of a 90° turn command 413B, a 135° parameter module 413C for storage of a 135° turn command 413C, and a 180° parameter module 413D for storage of a 180° turn command 413D.

In this way, the left-turn command 411, the right-turn command 412, and the degree parameter command 413 are collected to form a computer program. The programmable assembly toy system 100 further comprises a computer 130 either in the trigger module 120 or in the physical presentation object 300 to execute the computer program, wherein the computer program is corresponding to the preconfigured action. The preconfigured action may be a single action and a multiplicity of actions. As just one example further illustrating the programmable assembly toy system 100 is that the direction parameter module 410 is configured to control a moving action of the physical presentation object 300, wherein the physical presentation object 300 is triggered by the left-turn command 411 to turn left, and the physical presentation object 300 is triggered by the right-turn command 412 to turn right, and the physical presentation object 300 is triggered by one or more predetermined degrees of parameter modules 413 to turn predetermined degrees of action. As specific examples, the physical presentation object 300 may be activated to turn 45 degrees by the 45° turn command 413A, and the physical presentation object 300 may be activated to turn 90 degrees by the 90° turn command 413B, and the physical presentation object 300 may be activated to turn 135 degrees by the 135° turn command 413C, and the physical presentation object 300 may be activated to turn a 180 degrees by the 180° turn command 413D.

In some alternative aspects of the commands generated by the direction parameter module 410 may be collected to form the computer program to activate the physical presentation object 300 to perform the single step of action or the multiplicity of combined actions. As an example, the computer program, including the right-turn command 412 and the 45° turn command 413A, may activate the physical presentation object 300 to perform a right-turn with 45 degrees action. As another example, the computer program, including the left-turn command 411 and the 90° turn command 413B, may activate the physical presentation object 300 to perform a left-turn with 90 degrees action.

In some embodiments, the programmable assembly toy system 100 may further comprise a compiler associated with the computer for compiling the computer program from the direction parameter modules 410 to generate a compiled computer program and for executing the compiled computer program. Alternatively, the programmable assembly toy system 100 may further comprise an interpreter associated with the computer for interpreting the computer program from the direction parameter modules to generate an interpreted computer program and for executing the interpreted computer program. In one aspect, the computer program may be interpreted or complier prior to being executed by the computer. In another aspect, the computer program may be executed by the computer without being interpreting or complying by the interpreter or the complier.

It should be noted that in some embodiments, the direction parameter module 410 may be responsive to the direction module 113 and may not be responsive to the move module 111, the LED module 112, the sound module 114, and the loop module 115. In other ways, the direction parameter module 410 excludes the responsion with the move module 111, the LED module 112, the sound module 114, and the loop module 115.

Turning now to FIG. 3, the parameter modules 400 further comprises a move parameter module 420, wherein the move parameter module 420 comprises a speed parameter module 421 having a memory for storage of a speed command 421, a forward move parameter module 423 having a memory for storage of a forward move command 423, a backward move parameter module 422 having a memory for storage a backward move command 422, and a distance parameter module 424 having a memory for storage of a distance move command 424, wherein the speed parameter module 421 further comprises one or more predetermined speed parameter module and each of the predetermined speed parameter module may have a memory for storage of a predetermined speed command. In one aspect, the predetermined speed parameter module may comprise a high speed parameter module 421A having a memory for storage of a high speed command 421A, a middle speed parameter module 421B having a memory for storage of a middle speed command 421B, and a low speed parameter module 421C having a memory for storage of a low speed command 421C.

In this way, the speed command 421, the forward move command 423, the backward move command 422, and the distance move command 424 may be collected to form a computer program, wherein the computer program may be executed by the computer 130 to trigger the actions performing by the physical presentation object 300. As specific examples, the physical presentation object 300 may be activated by the speed command 421 to perform a predetermined speed action, such as a high speed action, a middle speed action, and a low speed action. The physical presentation object 300 may be activated to move forward by the forward move command 423 or activated to move backward by the backward move command 422. In one aspect, and the distance parameter module 424 may control a distance which the physical presentation object 300 is moving from, wherein distance parameter module 424 may comprise a multiplicity of predetermined distance parameter modules 424 and each of the predetermined distance parameter modules 424 may have a memory for storage a predetermined distance move command 424. As an example, the predetermined distance parameter modules 424 may be a ten centimeter module having a memory for storage of a ten centimeter command to activate the physical presentation object 300 for moving ten centimeters.

In some alternative aspects of the commands generated by the move parameter module 420 may be collected to form the computer program which may be executed by the computer 130 to activate the physical presentation object 300 to perform the single step of action or the multiplicity of combined actions. As an example, the computer program, including the high speed command 421A, the forward move command 423, and ten centimeter command 424, may activate the physical presentation object 300 to perform a high-speed forward movement with ten centimeters.

In some embodiments, as shown in FIG. 5, the move parameter module 420 may comprise a control number parameter module 440 having a memory for storage of a control number parameter command 440, wherein the control number parameter command 440 may control the frequency of the actions performed by the physical presentation object 300. In one aspect, the control number parameter module 440 may be stacked under the distance parameter module 424. As an example, the high speed command 421A, the forward move command 423, and the control number parameter command 441 may be collected to form the computer program to be executed by the computer to activate the physical predetermined object 300 to perform a high-speed forward movement with the predetermined frequency, such as one time of the movement, two times of the movement, or predetermined number of times of the movement.

It should be noted that in some embodiments, the move parameter module 420 may be responsive to the move module 111 and may not be responsive to the direction module 113, the LED module 112, the sound module 114, and the loop module 115. In other ways, the move parameter module 420 excludes the responsion with the direction module 113, the LED module 112, the sound module 114, and the loop module 115.

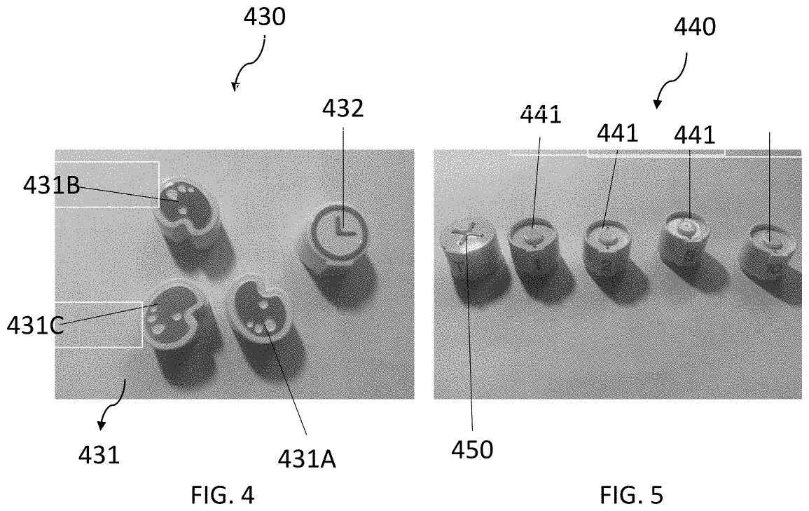

Continuing with FIGS. 4-5, the parameter modules 400 further comprises a LED parameter module 430, wherein the LED parameter module 430 may further comprise one or more light parameter modules 431 having a memory for storage of a light parameter command 431 with each light parameter module, one or more time parameter modules 432 having a memory for storage of a time parameter command 432 with each time parameter module, and one or more frequency parameter modules 450 having a memory for storage of a frequency parameter command 450 with each frequency parameter module, wherein the light parameter modules 430 may comprise a predetermined light module having a memory for storage of a predetermined light parameter command to be executed by the computer 130 to perform a predetermined light effect. As specific example, the predetermined light module may comprise a blue light module 431A having a memory for storage of a blue light parameter command 431A, a red light module 431B having a memory for storage of a red light parameter command 431B, and a green light module 431C having a memory for storage of a green light parameter command 431C, wherein the blue light parameter command 431A may control the physical presentation object 300 to perform a blue light effect, and the red light parameter command 431B may control the physical presentation object to perform a red light effect, and the green light parameter 431C command may control the physical presentation object to perform a green light effect.

In some embodiments, the time parameter module 432 and the frequency parameter module 450 may be stacked on each one of control number parameter modules 440 respectively having a memory for storage a control number parameter command 441 with each of the control number parameter modules 441, wherein the time parameter module 432 may be stacked on one of the control number parameter modules 441 and the frequency parameter command may stacked on the other one of the control number parameter modules 411. In other words, each of the control number parameter modules 441 may be stacked under each one of the frequency parameter modules 450, and each of the control number parameter modules may be stacked under each one of the time parameter modules 432.

In one aspect, the time parameter module 432 may control a retention time (a corresponding period of time) for the predetermined light effect, and the frequency parameter command 450 may control the frequency of the predetermined light effect. Each one of the time parameter command 432 may be associated with the control number parameter command 441 and the predetermined light parameter command 431 respectively to form the computer program which may activate the physical predetermined object 300 to perform a corresponding light effect with a corresponding period of time.

In another aspect, one of the frequency parameter commands 450 may be associated with each one of the control number parameter commands 441 and one of the predetermined light parameter command 431 may be associated with another one of the control number parameter commands 441, forming the computer program which may activate the physical predetermined object 300 to perform a corresponding light effect with a corresponding frequency.

In some alternative aspects of the commands generated by the LED parameter module 430 may be collected to form the computer program which may be executed by the computer 130 to activate the physical presentation object 300 to perform the single step of light effect or the multiplicity of combined step of light effect. As an example, the computer program, including the blue light parameter command 431A, the time parameter command 432 associated with one of the control number parameter module (a control number 2 parameter module shown in the example) 441, and the frequency parameter command 450 associated with the other one od the control number parameters (a control number 1 parameter module shown in the example) 441, may be collected to form the computer program which may control the physical presentation object to perform the blue light effect with a corresponding period of time (two seconds shown in the example) for a corresponding frequency (one time shown in the example).

It should be noted that in some embodiments, the LED parameter module 430 may be responsive to the LED module 112 and may not be responsive to the direction module 113, the move module 111, the sound module 114, and the loop module 115. In other ways, the LED parameter module 112 excludes the responsion with the direction module 113, the move module 111, the sound module 114, and the loop module 115.

The present the LED parameter module 430 also features that the time parameter module 432 and frequency parameter module 450 may be responsive to the LED module 112 by being associated with the control number parameter module 440 and may not be responsive to the LED module 112 without being associated with the control number parameter modules 440.

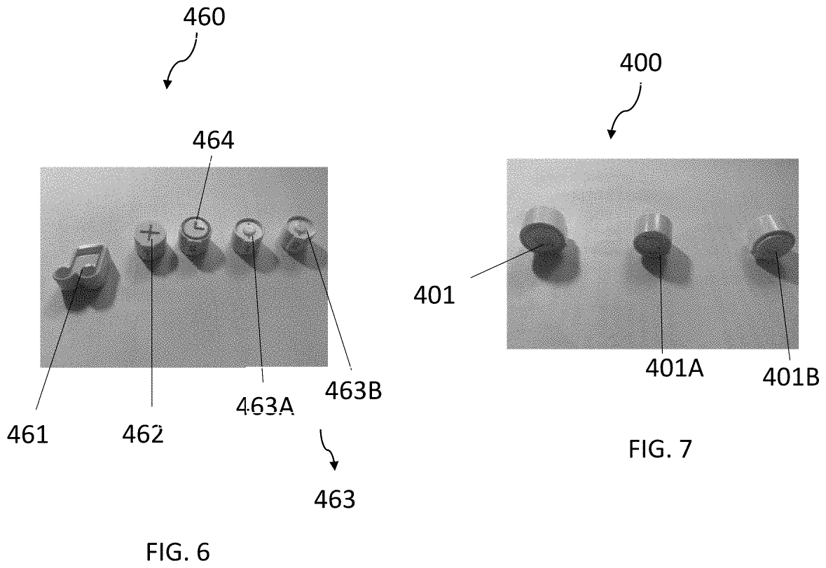

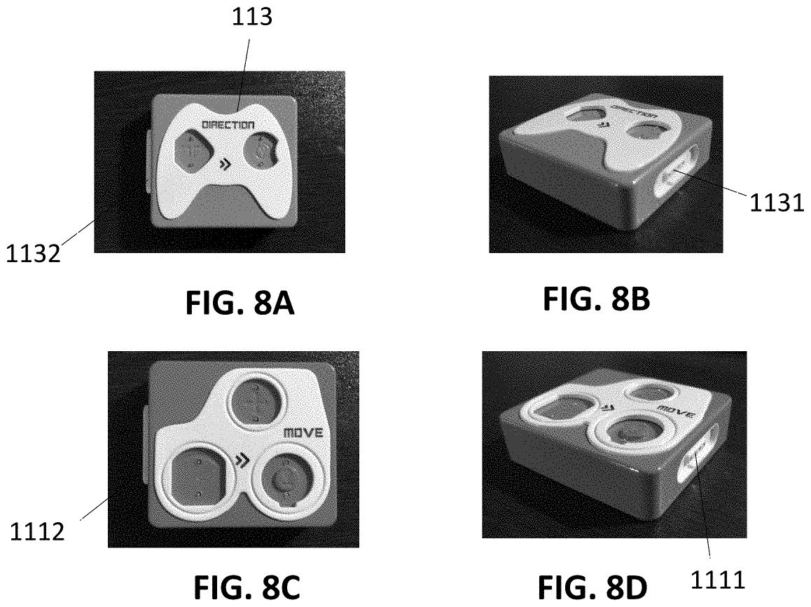

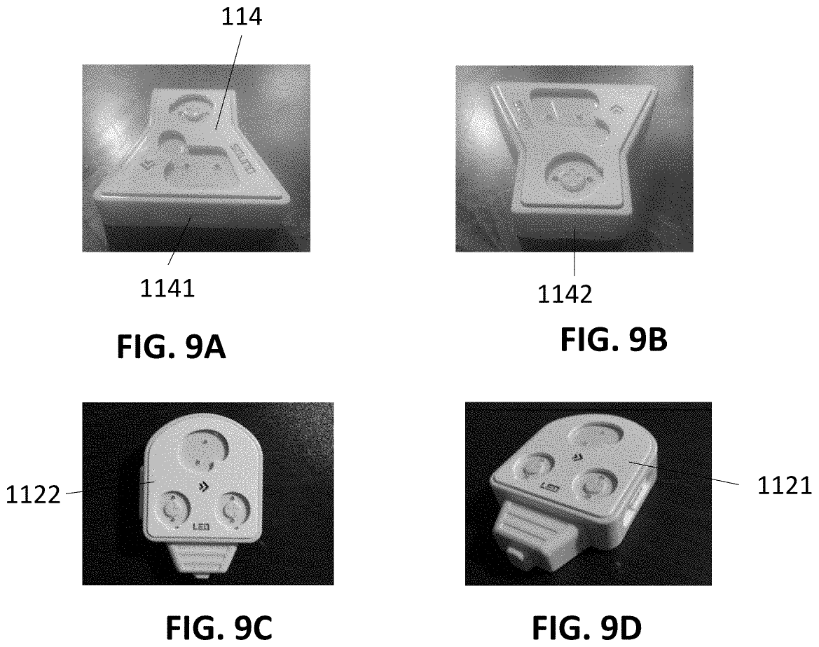

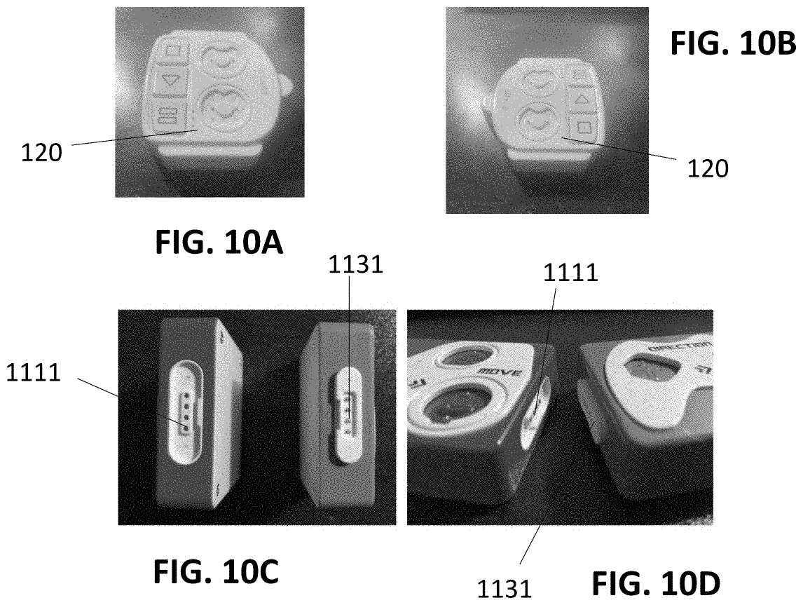

Continuing with FIG. 6, the parameter modules 400 further comprises a sound parameter module 460, wherein the sound parameter module 460 further comprises one or more music parameter module 461 having a memory for storage of a music parameter command 461 and a frequency parameter module 462 for storage of a frequency parameter command 462 or a time parameter module 464 for storage of a time parameter command 464.

In some embodiments, the sound parameter module 460 may comprise one or more control number parameter modules 463 having a memory for storage of a control number parameter command 463 with each control number parameter module, wherein each of the control number parameter modules 463 is stacked under the time parameter module 464 or the frequency parameter module 462; in such way, the music parameter command 461 and the frequency parameter command 462 associated with the control number parameter command 463 may be collected to form the computer program which is executed by the computer 130 to trigger the physical presentation object 300 for performing a corresponding music source with a predetermined frequency of time. As a specific example, the music parameter command 461 and the frequency parameter command 462 associated with a control number one command 463A, may form the computer program to be executed by the computer 130 to trigger the physical presentation object 300 for performing the corresponding music with one time.

In another embodiment, the music parameter command 461 and the time parameter command 464 associated with the control number parameter command 463 may be collected to form the computer program which may be executed by the computer 130 to trigger the physical presentation object 300 for performing a corresponding music source with a predetermined period of time. As a specific example, the music parameter command 461 and the time parameter command 464 associated with the control number one command 463A, may form the computer program to be executed by the computer 130 to trigger the physical presentation object 300 for performing the corresponding music with one minute of time period.

In another embodiment, a programmable assembly toy system 100 comprises a multiplicity of second function modules 500, and a physical presentation object 300 connected with a trigger module 120 in a wireless connection or a wired connection and performing a preconfigured action, wherein each of the second function modules 500 comprises a programming FIG. 501 corresponding to the preconfigured action. In such a way, the trigger module 120 or the physical presentation object 300 may be able to capture the programmable FIG. 501 to form the computer program which may be executed by the computer 130 to trigger the physical presentation object 300 to perform the preconfigured action.

In still another embodiment, a programmable assembly toy system 100 comprises an input function module 600 connected with a trigger module 120 in a wireless connection or a wired connection and creating a computer program command to form a computer program corresponding to a preconfigured action, wherein the input function module 600 may be a tool which can create the computer program command. Preferably, the input function module 600 may be a touch screen, a keyboard, or a compatible personal device.

According to all of the embodiments and aspects described herein, the programmable assembly toy system 100 further comprises a voice recognition module 122, in the trigger module 120 or the physical presentation object 300, to recognize an external voice source 200 to form the computer program command.

According to all of the embodiments and aspects described herein, each of the first function modules 110 may be two-dimensionally connected with each other and each of the function parameter module 400 may be three-dimensionally stacked with each other.

According to all of the embodiments and aspects described herein, the programmable assembly toy system 100 comprises a computer 130 either in the trigger module 120 or in the physical presentation object 300 to execute the computer program, wherein the computer program is corresponding to the preconfigured action.

According to all of the embodiments and aspects described herein, the programmable assembly toy system 100 may further comprise a compiler associated with the computer for compiling the computer program from the direction parameter modules to generate a compiled computer program and for executing the compiled computer program. Alternatively, the programmable assembly toy system may further comprise an interpreter associated with the computer for interpreting the computer program from the direction parameter modules to generate an interpreted computer program and for executing the interpreted computer program. In one aspect, the computer program may be interpreted or complier prior to being executed by the computer. In another aspect, the computer program may be executed by the computer without being interpreting or complying by the interpreter or the complier.

According to all of the embodiments and aspects described herein, each of the first function modules 110 comprises a female port 1131 and a male port 1132, wherein the female port 1131 of one of the first function modules 113 may be electrically, two-dimensionally, and horizontally connected with the male port 1112 of the other one of the first function modules 111.

According to all of the embodiments and aspects described herein, as shown in FIG. 7, each of the parameter module 400 comprises a magnetizable surface 401 which is configured to magnetically connected with the first function modules 110.

According to all of the embodiments and aspects described herein, each of the control number parameter modules 440, 463 comprises a top magnetizable surface 401A and a bottom magnetizable surface 401B positioned at the opposite side of the top magnetizable surface 401A, wherein the top magnetizable surface 401A may magnetically connected with the magnetizable surfaces 401 of the distance parameter module 424, the time parameter module 432, 464, or the frequency parameter module 462, 450. In one aspect, the magnetizable surfaces 401 of the distance parameter module 424, the time parameter module 432, 464, or the frequency parameter module 462, 450 may be magnetically connected with the top magnetizable surface 401A of each of the control number parameter modules 440, 463. In another aspect, the bottom magnetizable surface 401B of each of the control number parameter modules 440, 463 may be repelled with the magnetizable surfaces 401 of the distance parameter module, the time parameter module, or the frequency parameter module.

According to all of the embodiments and aspects described herein, as shown in FIG. 1 the programmable assembly toy system 100 may further comprise a visual recognition module 123, located in the trigger module 120 or the physical presentation object 300, to capture the programming FIG. 501 on the multiplicity of second function modules 500.

According to all of the embodiments and aspects described herein, the loop module 115 comprises a memory for storage of a loop command 115, wherein the loop command may activate a repeat action for the computer program formed by the collected commands.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of the programmable assembly toy system have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

It is noted that the system 100 may include a self-examination module that is configured to check the connection of each module in the system. For example, if each module is correctly connected, a “green light” will be shown in each module. On the other hand, if one of the modules is not connected correctly, a “red light” will be shown in the corresponding module.

The words used in this specification to describe the various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A programmable assembly toy system, comprising:
a multiplicity of first function modules, each of the first function module having a first surface to fit into one or more parameter modules, each parameter module having a memory for storage a computer program command forming a computer program with each parameter module; and
a physical presentation object connected with a trigger module in a wireless connection or a wired connection and performing a preconfigured action; wherein
the trigger module is jointed with one or more first function modules and responsive to an external trigger action to trigger the preconfigured action.

2. The programmable assembly toy system of claim 1, further comprising a computer either in the trigger module or in the physical presentation object to execute the computer program.

3. The programmable assembly toy system of claim 2, wherein the preconfigured action performing by the physical presentation object is responsive to the corresponding computer program command.

4. The programmable assembly toy system of claim 3, wherein the first function modules comprises a direction module, a move module, a LED module, a sound module, and a loop module, wherein each one of the first function modules is horizontally connected the other one or more first function modules in a side by side connection.

5. The programmable assembly toy system of claim 4, wherein the parameter modules comprises a direction parameter module, the direction parameter module comprising a left-turn parameter module having a memory for storage a left-turn command, a right-turn module having a memory for storage a right-turn command, and one or more degree parameter module for storage a degree parameter command.

6. The programmable assembly toy system of claim 5, wherein the direction parameter module is responsive to the direction module and is not responsive to the move module, the LED module, and the sound module.

7. The programmable assembly toy system of claim 6, wherein the parameter modules further comprises a move parameter module, the move parameter module comprising a speed parameter module having a memory for storage a speed command, a forward move parameter module having a memory for storage a forward move command, a backward move parameter module having a memory for storage a backward move command, and a distance parameter module having a memory for storage a distance move command.

8. The programmable assembly toy system of claim 7, wherein the move parameter module is responsive to the move module and is not responsive to the direction module, the LED module, and the sound module.

9. The programmable assembly toy system of claim 8, wherein the parameter modules further comprises a LED parameter module, the LED parameter module comprising one or more light parameter modules having a memory for storage a light parameter command with each light parameter module, one or more time parameter modules having a memory for storage a time parameter command with each time parameter module, and one or more frequency parameter modules having a memory for storage of a frequency parameter command with each frequency parameter module.

10. The programmable assembly toy system of claim 9, wherein the LED parameter module is responsive to the LED module and is not responsive to the move module, the direction module, and the sound module.

11. The programmable assembly toy system of claim 10, wherein the parameter modules further comprises a sound parameter module, the sound parameter module comprising one or more music parameter module having a memory for storage of a music parameter command with each music parameter module and a frequency parameter module for storage of a frequency parameter command.

12. The programmable assembly toy system of claim 11, wherein the parameter module further comprises one or more control number parameter modules, each of the control number parameter module being stacked with the time parameter module or the frequency parameter module of the LED parameter module, each of the control number parameter module being stacked with the frequency parameter module of the sound parameter module.

13. A programmable assembly toy system, comprising:
a multiplicity of second function modules, each of the second function modules having a programming figure corresponding to a preconfigured action;
a physical presentation object connected with a trigger module in a wireless connection or a wired connection and performing the preconfigured action; wherein
the programmable figure is captured by a visual recognition module, in the trigger module or the physical presentation object, to form a computer program; wherein
the trigger module is responsive to an external trigger action to trigger the preconfigured action.

14. The programmable assembly toy system of claim 13, further comprising a computer either in the trigger module or in the physical presentation object to execute the computer program.

15. A programmable assembly toy system, comprising:
an input function module connected with a trigger module in a wireless connection or a wired connection and creating a computer program command to form a computer program corresponding to a preconfigured action;
a physical presentation object connected with the trigger module in a wireless connection or a wired connection and performing the preconfigured action; and
a computer either in the trigger module or in the physical presentation object to execute the computer program; wherein
the trigger module is responsive to an external trigger action to trigger the preconfigured action.

16. The programmable assembly toy system of claim 15, wherein the input function module is a touch screen.

17. The programmable assembly toy system of claim 15, wherein the input function module is a keyboard.

18. The programmable assembly toy system of claim 15, wherein the input function module is a compatible personal device which is capable to create the computer program command.

19. The programmable assembly toy system of claim 15, further comprising a voice recognition module, in the trigger module or the physical presentation object to recognize an external voice source to form the computer program command.

20. The programmable assembly toy system of claim 1, wherein each of the first function modules is two-dimensionally connected with each other and each of the function parameter module is three-dimensionally stacked with each other.

21. The programmable assembly toy system of claim 1, further comprising a self-examination module configured to check if each module is correctly connected.
